(19) United States
(12) Patent Application Publication
(10) Pub. No.: US 2012/0280156 A1
(43) Pub. Date: Nov. 8, 2012

(54) TRAP PRIMER VALVE ASSEMBLY WITH BATTERY PACK AND TIMER

(75) Inventors: Jack S. Vilendre, West Linn, OR (US); M. Kevin Hardwick, North Plains, OR (US); Dwayne M. Abelein, Portland, OR (US)

(73) Assignee: JL INDUSTRIES, INC., Portland, OR (US)

(21) Appl. No.: 13/553,426

(22) Filed: Jul. 19, 2012

Related U.S. Application Data
(63) Continuation of application No. 13/193,409, filed on Jul. 28, 2011, now abandoned.
Application No. 13/193,409 is a continuation of application No. 12/686,833, filed on Jan. 13, 2010, now abandoned.
Application No. 12/686,833 is a continuation of application No. 11/810,465, filed on Jun. 5, 2007.

(51) Int. Cl. F16K 31/02

(52) U.S. Cl. 251/129.04

(57) ABSTRACT

A self-contained trap primer valve assembly is housed in a cabinet and includes a conduit for connection to a building's water main to carry water under pressure, a valve is operatively mounted in the conduit and a solenoid is operable for selectively opening and closing the valve, wherein a low voltage battery and a timer mechanism connected to the battery and preset for selectively actuating the solenoid, opens and closes the valve for preselected durations.

### CROSS-REFERENCE TO RELATED APPLICATION

This application is a continuation of U.S. patent application Ser. No. 13/193,409, filed Jul. 28, 2011, which is a continuation of U.S. patent application Ser. No. 12/686,833, filed Jan. 13, 2010, which is a continuation of U.S. patent application Ser. No. 11/810,465, filed Jun. 5, 2007, both of which are incorporated herein by reference in their entirety for all purposes.

### BACKGROUND

The present invention relates to a trap primer valve assembly for metering water to prime a trap valve at selected intervals. The invention is directed to the provision of a trap primer valve assembly in which external power from the main of a house or building is not required to operate the trap primer valve. Rather, a battery pack and timer are installed, and are operatively connected to a solenoid valve which is operable for delivering a metered amount of water to the trap, according to a signal from the timer.

Municipal pluming and sanitary codes require that water be delivered automatically to sewer line water traps, and this ensures that the traps will operate efficiently. Conventionally, trap primer valves have been mounted in housings or cabinets, which include openings for receiving supply water from a building's water main and directing it through an on-off valve which in turn directs the water to the trap. This process is operated by means of a solenoid which operates a valve to meter water to the trap. In conventional systems, the solenoid is operated by power from a control box, mounted within the cabinet, and the control box receives its power from the electrical main, such as a 120 volt system in a home or residence. The control box includes a timer which is operable for actuating the solenoid to open the trap primer valve to permit water to flow to the trap, in preselected intervals.

As mentioned above, the conventional system uses a cabinet, which houses the trap primer valve assembly so that it may be connected to the main supply line, and such cabinets typically are mounted onto stud walls of a building, such as a home or residence, apartment, etc. Conventional systems require that the power delivered to the building be extended into the cabinet for connection to the control box, and this requires extra work on the part of the contractor and electricians to interconnect power from the building. In fact, codes require that an electrician be on the job to hook up the power to the timer. Inasmuch as there is labor involved already in interconnecting the cabinets with a water supply line, as well as a line to the trap, savings in installation costs would be advantageous if an electrician were not required.

It is an object of the present invention, accordingly, to provide a trap primer assembly which includes a cabinet, and a trap primer valve, in which the control mechanism includes a timer and a battery pack, which are operatively connected to a solenoid for operating the trap primer valve. A trap primer valve assembly, as so constructed, does not require power from an external source, such as 120 volt system from that delivered to the building or home.

In the context of the present invention, the power source is a battery pack, and in one preferred form, includes eight 3-volt batteries wired in series and parallel, which are mounted in a control box which is disposed within the cabinet, and in turn is connected to a timer mechanism which is preselected to operate the solenoid to open the trap primer valve for a preselected duration every 24 hours. Depending upon the particular building, the trap primer valve may be operated to meter water from the water main supply to the trap for a period of 10 seconds or thereabouts to deliver water to the trap. This has been found to be effective to maintain or prime the trap so that it contains water for the purpose of preventing odors from the sewer line from migration back into the water lines of the building, be it a home, residence, apartment, etc.

### BRIEF DESCRIPTION OF THE DRAWING

FIG. 1 is a top plan view, of a trap primer valve assembly of the present invention, showing a cabinet, with its cover removed, the inlet and conduit for connection to the water main, and the trap primer valve which is operated by a solenoid; a control box, with a timer mechanism and battery pack shown connected to a solenoid, and diagramically shown is the outlet connected to the trap of a building, such as a home, residence, apartment, etc.; and

FIG. 2 is a schematic view showing the battery pack, and an arrangement of eight 3-volt batteries.

### DETAILED DESCRIPTION OF THE PREFERRED EMBODIMENT

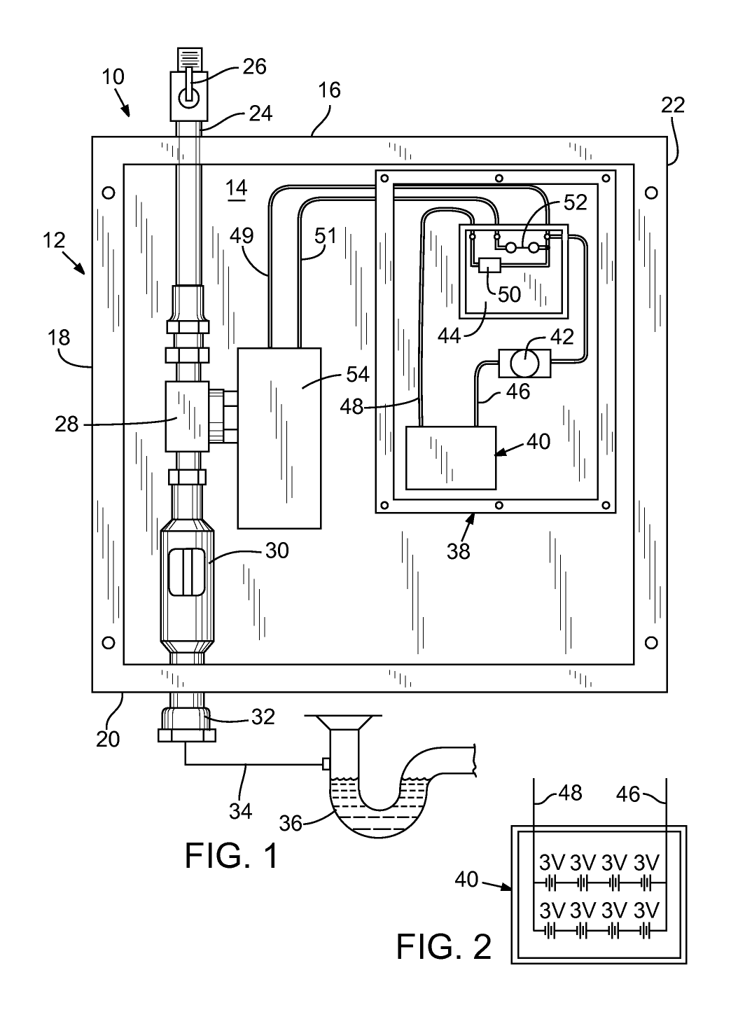

As stated at the outset, it is an object of the present invention to provide a self contained trap primer valve assembly in which there is no requirement for connection to the electrical main of the building, such as a home or residence, to operate the trap primer valve. Because the electrical main is eliminated, a source of power in the form of a battery, of low voltage is utilized. As shown in FIG. 1, a trap primer valve assembly is generally indicated at 10, and may include a housing, such as a cabinet, generally indicated at 12, which includes a bottom surface 14 and side walls such as indicated at 16, 18, 20 and 22. A top cover of the cabinet has been removed, to expose the trap primer valve and components of the control box as will be described. A water main supply line is indicated at 24, and an on/off valve 26 directs water from the main through a conduit to a trap primer valve 28. An air gap of conventional construction is shown at 30, and an outlet at 32. Diagrammatically shown from outlet 32, is a line 34 extending to trap 36, and it can be see that water is to be retained within the trap, and maintained at a desired level by having water from the main selectively metered into the trap at selected intervals.

A control box, generally located at 38, is mounted in cabinet 10, and is shown with its outer cover removed to show mounting therewithin of a battery pack generally indicated at 40, a reset button at 42 and a timer mechanism at 44. The battery pack is operatively connected by conductors 46 and 48 to the timer, whose input is shown at 50 and the load at 52. Power is delivered to operate a solenoid, indicated at 54 for selectively operating valve 28, through the conductors 49 and 51.

### Operation

As mentioned at the outset, it is desired to provide a timer mechanism, which operates at relatively low voltage, such as in conjunction with a low voltage battery (in the range of 10-20 volts, approximately). An example would be a 12 volt system, so that a low draw solenoid operates off the battery for a period of anywhere of up to approximately one year. The battery pack shown at 40, which is contemplated as a unit consisting of eight 3-volt batteries wired in series and parallel, is operatively connected through timer mechanism 44 to solenoid 54 (see FIG. 2). The solenoid draws minimal current, and the timer mechanism may be preset to open trap primer valve 28 for approximately 10 seconds every 24 hours. While this time sequence can of course be varied, it is determined that a duration of 10 seconds each 24 hours will draw approximately 1 ampere, and delivers approximately 2 oz. every 24 hours assuming a water pressure from the main at approximately 60 psi.

The solenoid, as indicated above, preferably is operable for operation under 12 volts, and an example of such solenoid is a model known as the Asco Redhat, manufactured by a company named Automatic Switch Company of Florham Park, N.J. This valving system enables the selected amount of priming water to be discharged to the trap during the time interval selected.

We claim:

1. A self-contained trap primer valve assembly comprising:
a conduit for connection to a building's water main to carry water under pressure;
a valve operatively mounted in the conduit;
a solenoid operable for selectively opening and closing the valve;
a low voltage battery; and
a timer mechanism connected to the battery and preset for selectively actuating the solenoid to open and close the valve for preselected durations.

2. The trap primer valve assembly of claim 1 wherein the battery and timer mechanism are interconnected to a reset mechanism, for resetting the timer.

3. The trap primer valve assembly of claim 1 wherein the battery provides low voltage, in the range of 10-20 volts for operating the solenoid, and wherein the solenoid.

4. The trap primer valve assembly of claim 2 wherein the timer and the battery are mounted in a control box which in turn is mounted in a cabinet which receives the conduit.

5. A self-contained trap primer valve assembly comprising:
a conduit for connection to a building's water main to carry water under pressure;
a valve operatively mounted in the conduit;
a solenoid operable for selectively opening and closing the valve;
a low voltage in the range of 10 to 20 volts;
a timer mechanism connected to the battery and preset for selectively actuating the solenoid to open and close the valve for preselected durations.
